(19) United States
(12) Patent Application Publication
(10) Pub. No.: US 2003/0213232 A1
(43) Pub. Date: Nov. 20, 2003

(54) Lean-burn gasoline engine including exhaust system therefor

(76) Inventors: Robert James Brisley, Duxford (GB); Daniel Swallow, Royston (GB); Martyn Vincent Twigg, Caxton (GB)

Correspondence Address: RATNERPRESTIA, P O BOX 980, VALLEY FORGE, PA, 19482-0980, US

(21) Appl. No.: 10/376,214

(22) Filed: Feb. 27, 2003

Related U.S. Application Data
(63) Continuation-in-part of application No. PCT/GB01/03840, filed on Aug. 28, 2001.

(30) Foreign Application Priority Data
Aug. 29, 2000 (GB) 0021118.5

(51) Int. Cl. F01N 3/00; F01N 3/10; C01B 35/00; C01B 33/00; C01B 31/00; C01G 30/00; C01G 28/00; C01B 25/00; C01B 23/00; C01B 21/00; B01J 8/02

(52) U.S. Cl. 60/285; 423/213.2; 60/301

(57) ABSTRACT

A lean-burn gasoline engine including an exhaust system, which system has a first oxidation catalyst for oxidizing engine-derived, unburned hydrocarbons during λ>1 conditions, and a NOₓ-trap downstream of the oxidation catalyst. Also included in one embodiment is by-pass means arranged between an upstream end and a downstream end of the oxidation catalyst and means for switching at least some exhaust gas flowing in the exhaust system to flow in the bypass during rich or stoichiometric running conditions, thereby substantially to prevent bypassed exhaust gas from contacting the oxidation catalyst. Included in the invention are methods of treating the exhaust gas streams with the apparati defined above.

### CROSS-REFERENCE TO RELTAED APPLICATIONS

This application is a National Phase Application of, and a Continuation-in-Part Application of, PCT/GB01/03840, which claimed the benefit of Great Britain Application No. 0021118.5 filed Aug. 29, 2000.

### FIELD OF INVENTION

The present invention relates to a lean bum gasoline engine comprising an exhaust system and in particular to a lean bum gasoline engine wherein the exhaust system comprises a NOₓ-trap.

### BACKGROUND

Manufacturers are increasingly interested in engines which operate under lean-running conditions to power their vehicles. One reason for this is because lean-bum engines produce less CO₂. This is advantageous because future emission legislation aims to reduce CO₂, but the consumer also benefits from the increased fuel economy.

One form of lean-bum engine is a gasoline direct injection engine, which is designed to operate under stoichiometric and lean conditions. When running lean, relatively low levels of nitrogen oxides (NOₓ) are formed that cannot be reduced (removed) in the presence of the relatively high levels of oxygen present. As a result NOₓ is stored in a “NOₓ-trap”, e.g. as nitrate, when running lean. Periodically the exhaust gas is enriched, and excess reductant, e.g. unburned hydrocarbon (HC), reduces stored NOₓ to nitrogen. When running lean the exhaust gas contains relatively high levels of unburned HC.

A system presently proposed for treating emissions from future gasoline direct injection engines comprises a close-coupled three-way catalyst (TWC) and an underfloor NOₓ-trap. The NOₓ-trap is positioned underfloor because in order to be able to store NOₓ thermodynamically, it has to be below about 550° C. The primary role of the TWC is to control emissions under stoichiometric conditions. It should reach light-off temperature relatively rapidly so as to reduce cold-start emissions.

The main problem with the proposed system is its ability to deal with the relatively high levels of HC when running lean. The TWC is not designed to do this, nor is the NOₓ-trap. Meeting future legislation requirements for lean-bum engines in general, and lean-bum gasoline engines in particular, is difficult with respect to HC.

### SUMMARY OF INVENTION

The present invention provides a lean-burn gasoline engine comprising an exhaust system, which system comprises a first oxidation catalyst for oxidizing engine-derived, unburned hydrocarbons during λ>1 conditions, and a NOₓ-trap downstream of the first oxidation catalyst.

Also included in the present invention is a lean-burn gasoline engine comprising an exhaust system, which system comprises a first oxidation catalyst for oxidizing unburned hydrocarbon (HC) during λ>1 conditions, a NOₓ-trap downstream of the oxidation catalyst, by-pass means arranged between an upstream end and a downstream end of the NOₓ-trap and means for switching at least some exhaust gas flowing in the exhaust system to flow in the bypass during rich or stoichiometric running conditions, thereby substantially to prevent bypassed exhaust gas from contacting the oxidation catalyst.

In addition to these engine exhaust systems, the present invention also includes a method of reducing the amount of unburned hydrocarbons in exhaust gases from a lean-burn gasoline engine during λ>1 conditions, which method comprises passing lean exhaust gases over an oxidation catalyst to form H₂O and CO₂ before passing the exhaust gases over a NOₓ-trap.

More specifically, the present invention includes a method of reducing the amount of unburned hydrocarbons in exhaust gases from a lean-burn gasoline engine, which method comprises the steps of: (a) operating a gasoline engine at λ>1 conditions and forming an exhaust stream from the engine; (b) passing the exhaust from the gasoline engine operated in step (a) through an oxidation catalyst to oxidize unburned hydrocarbons from the engine to generate an oxidized stream; (c) passing the oxidized stream exiting the oxidation catalyst of step (b) through an NOₓ trap to trap and store NOₓ; and (d) periodically running the gasoline engine rich so that the NOₓ trapped and stored during step (c) is catalytically reduced in the presence of unburned hydrocarbons from the engine running under rich conditions.

Still yet another embodiment of the method according to the invention is a method of reducing the amount of unburned hydrocarbons in exhaust gases from a lean-burn gasoline engine comprising the steps of: (a) operating a gasoline engine at λ>1 conditions and forming an exhaust stream from the engine; (b) passing the exhaust exiting the engine from step (a) through an SOX trap to trap and store SOₓ; (c) passing the stream exiting the SOₓ trap through a first oxidation catalyst to oxidize unburned hydrocarbons from the engine to generate an oxidized stream; (d) passing the oxidized stream exiting the first oxidation catalyst of step (c) through an NOₓ-trap to trap and store NOₓ; (e) periodically running the gasoline engine rich so that the NOₓ trapped and stored during step (d) is catalytically reduced in the presence of unburned hydrocarbons from the engine running under rich conditions; and (f) passing the stream exiting the NOₓ-trap of step (e) through a second oxidation catalyst downstream of the NOₓ-trap to further oxidize unburned hydrocarbons. Optionally, a clean-up catalyst may be used instead of a second exidation catalyst in step (f).

### BRIEF DESCRIPTION OF THE FIGURES

In order that the invention may be more fully understood, preferred embodiments of systems for use in the engine according to the invention will now be described with reference to the accompanying drawings, in which:

FIG. 1 is a schematic diagram of a prior art exhaust system proposed for use with GDI engines;

FIG. 2 is a schematic diagram of an exhaust system provided for the purposes of comparison in the Example below;

FIG. 3 is a schematic diagram showing an exhaust system embodying the basic concept of the present invention for use in lean-burn gasoline engines;

FIG. 4 is a schematic diagram showing an alternative embodiment of the exhaust system shown in FIG. 3;

FIG. 5 is a schematic diagram showing an embodiment of the exhaust system of the invention including a three-way catalyst;

FIG. 6 is a schematic diagram showing an embodiment of the exhaust system of the invention including a SOₓ-trap;

FIG. 7 is a schematic diagram showing an embodiment of the exhaust system of the invention including a clean-up catalyst;

FIG. 8 is a schematic diagram showing an embodiment of the exhaust system of the invention including a three-way catalyst and a SOₓ-trap;

FIG. 9 is a schematic diagram showing an embodiment of the exhaust system of the invention for including a three-way catalyst, a SOₓ-trap and a clean-up catalyst; and

FIG. 10 is a schematic diagram showing an embodiment of the exhaust system according to the invention including an oxidation catalyst bypass.

### DETAILED DESCRIPTION

We have now found that, very surprisingly, HC aftertreatment can be improved for lean-burn engines if an oxidation catalyst is included in the exhaust system upstream of a NOₓ-trap. In one embodiment of the invention, a lean-burn gasoline engine comprises an exhaust system having a first oxidation catalyst for oxidizing engine-derived, unburned hydrocarbons during λ>1 conditions, and a NOₓ-trap downstream of the oxidation catalyst.

According to another embodiment, the invention provides a lean-burn gasoline engine comprising an exhaust system, which system comprises a first oxidation catalyst for oxidizing unburned hydrocarbon (HC) during λ>1 conditions, a NOₓ-trap downstream of the oxidation catalyst, by-pass means arranged between an upstream end and a downstream end of the NOₓ-trap and means for switching at least some exhaust gas flowing in the exhaust system to flow in the bypass during rich- or stoichiometric-running conditions, thereby substantially to prevent bypassed exhaust gas from contacting the oxidation catalyst.

By “lean-bum gasoline engine” herein, we mean an engine which is controlled so that during at least part of its normal operation it runs on a lean of stoichiometric air-to-fuel ratio, i.e. where λ>1. Lean-bum gasoline engines as defined herein include partial lean-bum gasoline engines using a variety of injectors including those with air assisted direct injection and high-pressure direct injection.

An oxidation catalyst is purposely designed to provide for the reaction of gaseous components with oxygen, typically in as wide a temperature range as possible, especially lower temperatures. The catalyst oxidizes whenever oxygen is available for reaction in the gas stream. The catalysts selected for use in the present invention are suitable to catalyze the exhaust gas reactants to H₂O and CO₂. Active components of such oxidation catalysts can include platinum, palladium or a base metal active for oxidation such as copper, molybdenum, cobalt or any other transition element that is active for oxidation.

In distinction, a partial oxidation (or POx) catalyst is purposely designed to provide for the incomplete oxidation of reactants, such as to CO and H₂ in rich exhaust gas conditions. An example is the partial oxidation of carbon with steam to produce hydrogen, known as “steam reforming”. Suitable steam reforming catalysts include nickel and rhodium.

A TWC is purposely designed to oxidize HC and carbon monoxide and at the same time to reduce NOₓ. Whilst an oxygen storage component (OSC) can be included to extend the operating window of the TWC, the TWC is designed to operate at or close to an air-to-fuel ratio of λ=1. Typical TWC active components are platinum and/or palladium for oxidation and rhodium for reduction. The OSC can be ceria based.

GB-A-2342056 describes a catalytic converter for an internal combustion engine such as a gasoline direct injection engine including a NOₓ-trap having on an upstream portion an OSC. The OSC absorbs oxygen during lean-running and releases it during rich regeneration of the NOₓ-trap, the excess oxygen being used to oxidize HC and thereby increase the exotherm over the NOₓ-trap to enable more efficient desorption and reduction of NOₓ. Ceria-based OSC are not oxidation catalysts for HC under lean-running conditions.

A NOₓ-trap is purposely designed for absorbing and storing NOₓ during lean conditions, and releasing and catalytically reducing the stored NOₓ during rich conditions. This requires controlling the engine so that periodically it is run rich during lean operation. A NOₓ-trap typically includes active materials for three functions: an oxidation catalyst, such as platinum; an absorber, for example an alkali metal or an alkaline earth compound typified by barium carbonate; and a reduction catalyst, such as rhodium.

EP 0893144 describes a method and device for desulphating a NOₓ-trap in direct injection diesel engines. In one embodiment, an exotherm is generated over an upstream oxidation catalyst to heat the NOₓ-trap to a temperature sufficient to desorb the SOₓ under λ>1 condition. This is done by injecting additional HC and/or throttling the engine and retarding fuel injection while maintaining λ>1 condition. Alternatively, under λ<1 condition SOₓ is removed by generating, an almost oxygen-free exhaust stream with a CO content of between 1-10% by including a component in an oxidation catalyst upstream of the NOₓ-trap which promotes the water-gas shift.

EP 1008379 describes a method and device for treating NOₓ in an exhaust system of an internal combustion engine including a partial oxidation catalyst for increasing concentrations of carbon monoxide and hydrogen and decreasing the concentration of oxygen in the exhaust gas during rich conditions thereby to regenerate the NOₓ-trap.

Apart from the obvious advantage of reducing tailpipe-out HC levels, we have also found that in the embodiment in which the oxidation catalyst is upstream of the NOₓ NOₓ-trap, the oxidation catalyst enables the NOₓ-trap to work more efficiently. Thus for the same volume occupied by the NOₓ-trap substrate in the proposed aftertreatment system for gasoline direct injection described above, the combination of upstream oxidation catalyst and downstream NOₓ-trap of the invention provides a similar NOₓ-trap activity, but also enables the system to treat relatively high levels of HC. Put another way, the total cost of the platinum group metals between the NOₓ-trap only and the oxidation catalyst/NOₓ-trap of the invention is equivalent.

Although we do not wish to be bound by theory, we believe this phenomenon is brought about by the upstream oxidation catalyst promoting the reaction of NO with oxygen to produce NO₂, a function that is also performed by the oxidation catalyst component in the NOₓ-trap.

Consistent with the apparatus just described, the method of using the apparatus to treat an exhaust gas stream from a lean-bum gasoline engine comprises passing lean exhaust gases over an oxidation catalyst to form H₂O and CO₂ before passing the exhaust gases over a NOₓ-trap. More specifically, and in a preferred embodiment of this method, the method comprises the steps of: (a) operating a gasoline engine at λ>1 conditions and forming an exhaust stream from the engine; (b) passing the exhaust from the gasoline engine operated in step (a) through an oxidation catalyst to oxidize unburned hydrocarbons from the engine to generate an oxidized stream; (c) passing the oxidized stream exiting the oxidation catalyst of step (b) through an NOₓ-trap to trap and store NOₓ; and (d) periodically running the gasoline engine rich so that the NOₓ trapped and stored during step (c) is catalytically reduced in the presence of unburned hydrocarbons from the engine running under rich conditions.

Therefore, among the advantages of the present invention during lean-running of a lean bum gasoline engine are: reduced HC emissions; reduced CO emissions; oxidation of NO→NO₂; and removal of HC, which also provides efficiency of the NOₓ-trap (in addition to the other three advantages related to NOₓ mentioned above).

In the embodiment utilizing a bypass, the means for switching comprises an engine control unit (ECU) programmed, in use, to switch at least some exhaust gas flowing in the exhaust system to flow in the bypass during rich or stoichiometric running conditions. According to a further embodiment, the means for switching comprises at least one valve. The means for switching can control the rate of exhaust gas bypass. Suitable rates of exhaust gas bypass include from 50% to 100%, such as from 60% to 90% or from 70% to 80%.

In a method of treating exhaust gas using the bypass embodiment, the method would include the step of switching some exhaust gas flow through the bypass when stoichiometric running conditions, or rich running conditions, are caused to occur in order to regenerate the NOₓ-trap in accordance with the above. Once regeneration is sufficiently achieved, the method would include causing the valve to reestablish full flow of exhaust across the oxidation catalyst and concurrent return to lean operation of the gasoline engine.

In another embodiment the exhaust system of the engine of the invention includes another oxidation catalyst downstream of the NOₓ-trap. This catalyst can treat HC slip past the upstream oxidation catalyst and NOₓ-trap.

Advantageously, the oxidation catalyst is also an HC-trap. The HC-trap can include a zeolite, such as γ-type zeolites, ZSM-5 type zeolite and US-γ type zeolite, mordernite, β-zeolite, ZSM5. Where the HC-trap includes a zeolite it can be mixed with alumina, preferably platinum on alumina, silica-alumina, titania and/or zirconia. This embodiment is particularly useful in controlling HC immediately after start-up in that HC can be absorbed and then released when the HC-trap heats up. The released HC can then be oxidized downstream because, by the time the HC is released, the oxidation catalyst should have reached its light-off temperature. For further information on combining the temperature windows of HC-trap and a downstream catalyst, see EP-A-0830201.

Preferably, the active component of the oxidation catalyst for use in the present invention is a platinum group metal (PGM) or a mixture of any two or more thereof, although base metals or mixtures of any two or more thereof which are active for oxidation can also be used. Base metals active for oxidation include copper, nickel, molybdenum and cobalt, but any other active transition element can be used as appropriate. Where the active component is a PGM we prefer platinum, although palladium could be used instead. Combinations of any two or more PGMs can also be used, such as a mixture of platinum and palladium.

In preferred embodiments, the exhaust system of the engine according to the invention also includes a close-coupled three-way catalyst for gasoline applications. In further preferred embodiments, the system includes a SOₓ-trap upstream of the oxidation catalyst, but preferably, where present, downstream of the close-coupled three-way catalyst. Active materials for inclusion in compositions for SOₓ-traps include an alkaline earth metal compounds or an alkali metal compound or mixtures of any two or more thereof. Sulfur poisoning of catalyst materials is a known problem, and it is preferable to avoid SOₓ contacting the NOₓ-trap in the system, unless the conditions are such (high temperatures/rich, reducing conditions) that SOₓ is not absorbed to any of the catalytic materials of the exhaust system. SOₓ-trap regeneration can be effected by periodically visiting these conditions and this can be effected under the control of the engine control unit (ECU). As levels of sulfur in fuel arc reduced, it may not always be necessary to include a SOₓ-trap in the system. For further details on SOₓ-traps, reference can be made to our EP-A-0814242.

In a further preferred embodiment, the exhaust system of the engine according to the invention includes a clean-up catalyst downstream of the NOₓ-trap. This is particularly useful in systems including the SOₓ-trap wherein when the SOₓ-trap is regenerated H₂S can be produced, which has an unpleasant smell. In order to combat this, the clean-up catalyst comprises an oxygen storage element such as ceria, an oxidation component, such as platinum, a NOₓ reducing component, for example rhodium, and a component for suppressing H₂S, for example NiO, Fe₂O₃, MnO₂, CoO and CrO₂. In an alternative embodiment, the clean-up catalyst can also be configured so as to contend with HC slip past the oxidation catalyst of the invention, which can occur where there is insufficient oxygen in the gas stream to oxidize the HC to H₂O and CO₂. In this embodiment, the clean-up catalyst includes an oxygen storage component with catalytic activity, such as ceria.

Consistent with the presence of a SOx-trap in the apparatus just described, a method for its use comprises the steps of: (a) operating a gasoline engine at λ>1 conditions and forming an exhaust stream from the engine; (b) passing the exhaust exiting the engine from step (a) through an SOₓ trap to trap and store SOₓ; (c) passing the stream exiting the SOₓ trap through a first oxidation catalyst to oxidize unburned hydrocarbons from the engine to generate an oxidized stream; (d) passing the oxidized stream exiting the first oxidation catalyst of step (c) through an NOₓ-trap to trap and store NOₓ; (e) periodically running the gasoline engine rich so that the NOₓ trapped and stored during step (d) is catalytically reduced in the presence of unburned hydrocarbons from the engine running under rich conditions; and (f) passing the stream exiting the NOₓ-trap of step (e) through a second oxidation catalyst downstream of the NOₓ-trap to further oxidize unburned hydrocarbons.

The oxidation catalyst and the NOₓ-trap can each be provided on a separate substrate such as a flow-through honeycomb monolith. The monolith can be metal or ceramic; where ceramic it can be cordierite, although alumina, mullite, silicon carbide, zirconia or sodium/zirconia/phosphate are alternatives. In a particularly preferred embodiment the NOₓ-trap and the oxidation catalyst are provided on a single substrate or “brick”, each occupying a distinct zone. Manufacture of coated substrate can be carried out by methods known to the person skilled in the art and no further explanation will be given here. Preferably the NOₓ-trap and the oxidation catalyst substrate(s) are in one shell or can.

According to a further aspect, the invention provides a vehicle including a lean-burn gasoline engine according to the invention. The engine can be a gasoline direct injection (GDI) engine. Preferred exhaust systems for a lean-burn gasoline engine include a close-coupled TWC upstream of the oxidation catalyst. The exhaust system of the engine according to the invention can also include a SOₓ-trap upstream of the NOₓ-trap (downstream of the TWC, where present); and a clean-up catalyst downstream of the NOₓ-trap.

Further preferred embodiments of the present invention are described in the specific description below with reference to the accompanying drawings.

The oxidation catalyst and the NOₓ-trap are preferably positioned in the underfloor position of a vehicle. According to a further aspect, the invention provides a method of reducing the amount of unburned HC in exhaust gases from a lean burn gasoline engine during λ>1 conditions, which method comprises passing lean exhaust gases over an oxidation catalyst before passing the exhaust gases over a NOₓ-trap.

According to a further aspect, the invention provides use of an oxidation catalyst upstream of a NOₓ-trap for reducing the amount of unburned HC in λ>1 exhaust gases from a lean-burn gasoline engine.

Referring to the Figures, the reference numerals are as follows: 1 is an oxidation catalyst according to the invention; 2 is a NOₓ-trap; 3 is a three-way catalyst; 4 is a SOₓ-trap; 5 is a clean-up catalyst; U is an upstream end of the exhaust system; and D is a downstream end of the exhaust system.

We believe that the Figures are self-explanatory, and the following explanation is provided to enhance the understanding of certain embodiments shown therein.

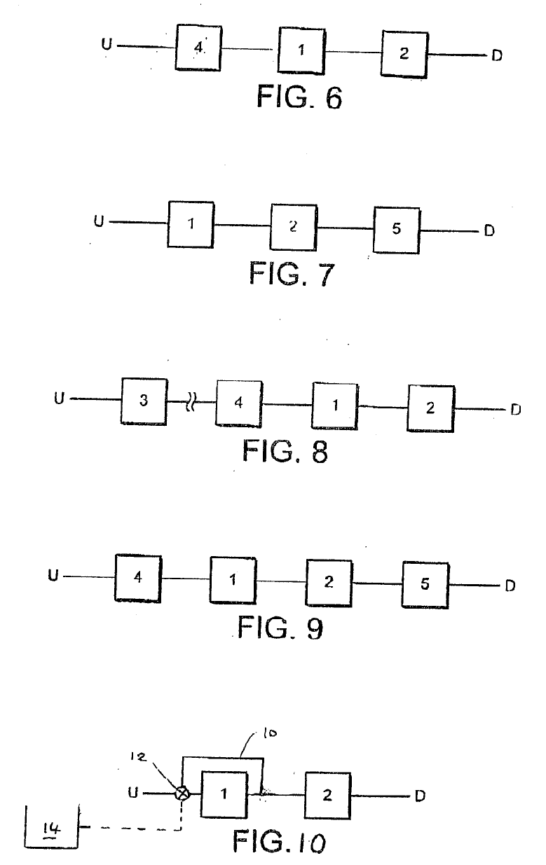

In each of FIGS. 3 to 10, the oxidation catalyst according to the invention is preferably an HC-trap. The HC-trap preferably includes a zeolite, such as y-type zeolites, ZSM-5 type zeolites and US-γ type zeolites. In an alternative embodiment, the HC trap is platinum supported on alumina.

In the embodiment shown in FIG. 9, the clean-up catalyst includes an oxygen storage element such as ceria, an oxidation component, such as platinum, a NOₓ reducing component, for example rhodium, and a component for suppressing H₂S, for example NiO, Fe₂O₃, MnO₂, CoO and CrO₂.

The embodiment shown in FIG. 10 is the embodiment shown in FIG. 3 with the addition of an oxidation catalyst bypass (10). Bypass (10) comprises a conduit, the rate of access of exhaust gas to which is controlled by valve (12). The attitude of valve (12) is controlled by engine control unit (ECU) (14) programmed, in use, to switch at least some exhaust gas flowing in the exhaust system to flow in the bypass during rich- or stoichiometric-running conditions. Depending on the degree of enrichment brought about by modulation of the air-to-fuel ratio, choking of the air supply or post combustion injection either in-cylinder or downstream thereof, the attitude of the valve can be controlled to bypass some or all of the exhaust gas flowing in the exhaust system. Suitable rates of bypass can be from 50% to 100%, such as 60% to 90% or from 70% to 80%.

In order that the invention may be more fully understood, the following Example is provided by way of illustration only.

### EXAMPLE

Apparatus

In a bench test cell, a 4 cylinder, 1.8-liter, 1997 model year, Mitsubishi direct injection engine from a vehicle calibrated for the Japanese market was installed with a direct current dynamometer. The original engine control unit (ECU) was disconnected and control of the engine was by an engine management and control system (EMACS). This was done so that an engine control strategy suitable for use with NOₓ-trap technology could be applied to the exhaust system for the purposes of our study. In particular, EMACS enabled complete control over ignition and injection timing and duration in both homogenous and lean-bum combustion modes.

The engine was operated from one of two sets of maps: one for the homogeneous mode and the other for the lean mode. Basic maps for ignition and injection timing and duration were generated by firstly logging data from the ECU of a vehicle including the same model of engine as the one used for the bench test and then basing the maps on this information by reverse engineering. In the homogenous mode, the engine was run at a range of engine speeds and loads and a supplementary map to the basic map was generated for the best emissions of NOₓ, CO and HC emissions under λ=1 operation. The lean mode was mapped by matching the torque achieved in homogenous mode at the same speed and load demand.

The positioning of the catalyst in the bench test rig was as follows. A palladium/rhodium three-way catalyst, at 93 g ft⁻³ palladium and 7 g ft⁻³ rhodium, on ceramic substrate of 400 cells per square inch ((cpsi) 62 cells cm⁻²) and 0.15 mm wall thickness and volume of 22% engine swept volume (ESV), was fitted in the close-coupled position approximately 30 cm from the engine exhaust manifold.

The downstream catalysts were of 133% ESV in total in the same de-mountable can and were fitted 200 cm back from the close-coupled catalyst, corresponding to the underfloor position. Sample points for measuring emissions were located before the starter catalyst and after the can housing the underfloor catalysts. Concentrations of NOₓ, HC, CO₂, CO and O₂ were measured using a dual bank of MEXA (Motor Exhaust Gas Analyzer) 9500 gas to allow continuous measurement of both pre-close-coupled catalyst and post-NOₓ trap gas concentrations. Thermocouples were fitted in the inlet and outlet cones of both the underfloor and starter catalyst and one thermocouple was placed 25 mm into the underfloor catalyst to give a 1 inch (2.54 cm) bed temperature measurement.

Prior to testing, the engine was thoroughly warmed up in idling condition. In homogenous mode, the engine was then run so that the inlet temperature to the underfloor catalyst was 210° C. It was then switched to lean operation and the exhaust gas re-circulation (EGR) valve position adjusted until the engine-out NOₓ was 300 ppm. The EGR valve position was recorded and is referred to as the lean set-point. The engine was switched back to homogeneous mode, and the EGR valve was closed. A rich set-point was obtained by increasing the fuel injector pulse width to obtain λ=0.80. A series of lean/rich cycles were run as follows. In the lean mode, the EGR valve was at the lean set-point position until the NOₓ efficiency of the system had dropped below 75%. The engine was then switched back to homogenous mode for 15 seconds, with injector duration at the rich set-point. The cycles were repeated five times and the results obtained for each of the cycles was logged. This procedure was repeated at other temperatures. Exhaust systems were fitted to the engine and the protocol above was followed and data collected.

The arrangement of the components in the exhaust systems tested is shown in Table 1 below. In all the tests reported the catalysts were in the aged condition. The three-way close coupled catalyst was hydrothermally aged at 1100° C. for 4 hours under 10% O₂ and 10% H₂O with a balance of nitrogen. The underfloor catalyst systems were hydrothermally aged at 850° C. for 4 hours under 2% O₂, 10% H₂O and a balance of nitrogen.

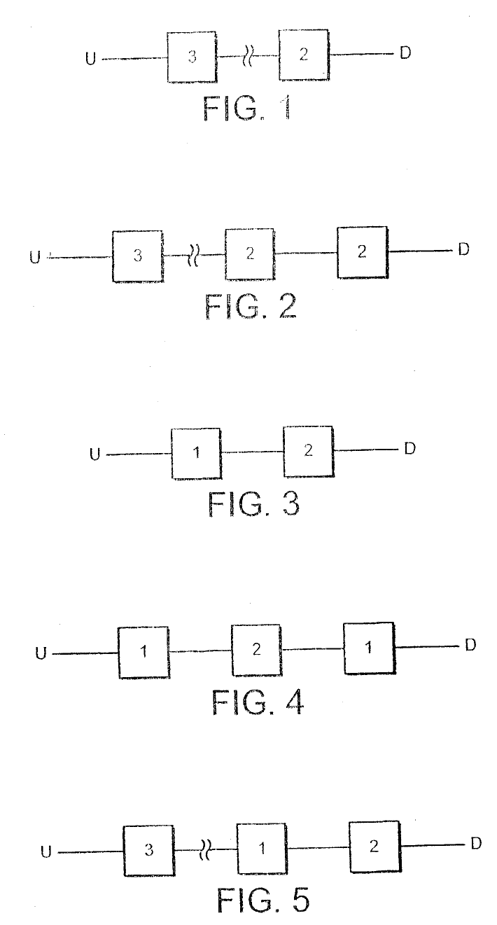

System 1 consists of upstream Catalyst A, a NOₓ-trap containing 100 g ft⁻³ (3.53 g 1⁻¹) platinum and 20 g ft⁻³ (0.7 g 1⁻¹) rhodium, coated on ceramic substrate of 400 cpsi (62 cells cm⁻²) and wall thickness 0.15 mm, at 33% ESV. Catalyst B is a NOₓ-trap at 60 g ft⁻³ (2.12 g 1⁻¹) platinum and 20 g ft⁻³ (0.7 g 1⁻¹) rhodium, coated on ceramic substrate of 600 cpsi (93 cells cm⁻²) and 0.1 mm wall thickness, and 100% ESV. This arrangement is shown schematically in FIG. 2 of the accompanying drawings.

System 2 consists of upstream Catalyst A, an advanced lean oxidation catalyst containing 100 gft⁻³ (35.3 g 1⁻¹) platinum coated onto an alumina-zeolite mixed material, at 33% ESV, coated on ceramic substrate at 400 cpsi (62 cells cm⁻²) and 0.15 mm wall thickness. Catalyst B is the same NOₓ-trap formulation described as Catalyst B in System 1. This arrangement is shown schematically in FIG. 5 of the accompanying drawings.

TABLE 1

| | Close-coupled | Catalyst A | |
|---|---|---|---|
| System | TWC? | (Upstream) | Catalyst B |
| 1 | Yes | NOₓ-trap | NOₓ-trap |
| 2 | Yes | Advanced oxidation | NOₓ-trap |
| | | catalyst | |

Results

Engine out HC and tailpipe HC are averages from 5 cycles.

System 1

TABLE 2

| Inlet temp to | Space velocity | | | HC | |
|---|---|---|---|---|---|
| underfloor | at U/F catalyst | HC engine- | HC tailpipe | conversion | |
| catalyst (° C.) | (h⁻¹) | out (ppm) | (ppm) | (%) | NOₓ stored (g) |
| 210 | 37,000 | 1809 | 600 | 67 | 0.11 |
| 291 | 44,000 | 1836 | 268 | 85 | 0.37 |
| 340 | 55,000 | 1800 | 203 | 89 | 0.45 |

TABLE 3

| Inlet temp to | Space velocity | | | HC | |
|---|---|---|---|---|---|
| underfloor | at U/F catalyst | HC engine out | HC tailpipe | conversion | |
| catalyst (° C.) | (h⁻¹) | (ppm) | (ppm) | (%) | NOₓ stored (g) |
| 210 | 37,000 | 1808 | 517 | 71 | 0.10 |
| 291 | 44,000 | 1814 | 173 | 91 | 0.42 |
| 340 | 55,000 | 1781 | 153 | 91 | 0.45 |

### CONCLUSION

System 2, which contains the oxidation catalyst upstream of the NOₓ-trap, has improved lean hydrocarbon conversions at 210, 291 and 340° C. in comparison to the NOₓ-trap only arrangement of System 1. Improvements of up to 6% HC conversions are observed at 291° C. and the mean improvement is of 2-3%. Improvements in emissions of this order are important to meet European Stage 1V legislation. The NOₓ storage function of System 2 has not deteriorated in comparison to System 1, despite the removal of 33% ESV of NOₓ storage capacity.

1. A lean-bum gasoline engine comprising an exhaust system, which system comprises a first oxidation catalyst for oxidizing engine-derived, unburned hydrocarbons during λ>1 conditions, and a NOₓ-trap downstream of the first oxidation catalyst.

2. The engine according to claim 1, further comprising a second oxidation catalyst downstream of the NOₓ-trap.

3. The engine according to either claim 1, wherein the first or second oxidation catalyst is selected from the group consisting of: a platinum group metal and a mixture of any two or more platinum group metals.

4. The engine according to claim 3, wherein the platinum group metal is platinum or palladium.

5. The engine according to claim 1, wherein said first oxidation catalyst oxidizes unburned hydrocarbons only from said lean-bum gasoline engine.

6. The engine according to claim 1, wherein the first oxidation catalyst also comprises a hydrocarbon-trap.

7. The engine according to claim 6, wherein the hydrocarbon trap includes a zeolite.

8. The engine according to claim 7, wherein the hydrocarbon trap further includes at least one of alumina, silica-alumina, titania and zirconia.

9. The engine according to claim 7, wherein the zeolite is selected from the group consisting of: β-zeolite, γ-type zeolite, ZSM-5 type zeolite and US γ-type zeolite.

10. The engine according to claim 6, wherein the hydrocarbon trap comprises platinum on alumina.

11. The engine according to claim 1, wherein the exhaust system also comprises a three-way catalyst (TWC).

12. The engine according to claim 1, wherein the system also comprises a SOₓ trap upstream of the NOₓ-trap.

13. The engine according to claim 11, wherein the TWC is upstream of the NOₓ-trap and wherein the exhaust system also comprises a SOₓ trap upstream of the NOₓ-trap and downstream of the TWC.

14. The engine according to claim 1, further comprising a clean-up catalyst downstream of the NOₓ-trap.

15. The engine according to claim 1, wherein the exhaust system comprises a substrate supporting, each in a distinct zone, the first oxidation catalyst and the NOₓ-trap.

16. The engine according to claim 15, wherein the substrate is a flow-through monolith.

17. The engine according to claim 1, wherein the exhaust system comprises a shell or can including the first oxidation catalyst and NOₓ-trap.

18. The engine according to claim 1, wherein the engine is a gasoline direct injection engine.

19. A vehicle including an engine according to claim 1.

20. The engine according to claim 3, wherein the platinum group metal is platinum.

21. The engine according to claim 2, wherein the second oxidation catalyst further comprises a hydrocarbon trap.

22. The engine according to claim 11, wherein the TWC is in the close-coupled position.

23. A method of reducing the amount of unburned hydrocarbons in exhaust gases from a lean-burn gasoline engine during λ>1 conditions, which method comprises passing lean exhaust gases over an oxidation catalyst to form H₂O and CO₂ before passing the exhaust gases over a NOₓ-trap.

24. A method of reducing the amount of unburned hydrocarbons in exhaust gases from a lean-bum gasoline engine, which method comprises the steps of:
(a) operating a gasoline engine at λ>1 conditions and forming an exhaust stream from the engine;
(b) passing the exhaust from the gasoline engine operated in step (a) through an oxidation catalyst to oxidize unburned hydrocarbons from the engine to generate an oxidized stream;
(c) passing the oxidized stream exiting the oxidation catalyst of step (b) through an NOₓ-trap to trap and store NOₓ; and
(d) periodically running the gasoline engine rich so that the NOₓ trapped and stored during step (c) is catalytically reduced in the presence of unburned hydrocarbons from the engine running under rich conditions.

25. The method of claim 24 further comprising the step:
(e) passing the stream exiting the NOₓ-trap of step (c) through a second oxidation catalyst downstream of the NOₓ-trap.

26. The method of either claim 24, wherein the first or second oxidation catalyst is selected from the group consisting of: a platinum group metal and a mixture of any two or more platinum group metals.

27. The method of claim 26 wherein the platinum group metal is platinum or palladium.

28. The method of claim 24, wherein the first oxidation catalyst oxidizes unburned hydrocarbons only from the lean-burn gasoline engine.

29. The method of claim 24, wherein the oxidation catalyst also comprises a hydrocarbon trap.

30. The method of claim 29, wherein the hydrocarbon trap includes a zeolite.

31. The method of claim 30, wherein the hydrocarbon trap further includes at least one of alumina, silica-alumina, titania and zirconia.

32. The method of claim 30, wherein the zeolite is selected from the group consisting of: β-zeolite, γ-type zeolite, ZSM-5 type zeolite and US γ-type zeolite.

33. The method of claim 29, wherein the hydrocarbon trap comprises platinum on alumina.

34. The method of claim 24, further comprising the step of, between steps (a) and (b), passing the exhaust from the gasoline engine operated in step (a) through a three-way catalyst.

35. The method of claim 24, further comprising the step of, between steps (a) and (b), passing the exhaust from the gasoline engine operated in step (a) through a SOₓ trap.

36. The method of claim 35, wherein the SOₓ trap is upstream of the NOₓ-trap and downstream of the TWC.

37. The method of claim 24, further comprising the step of:
(e) passing the stream exiting the NOₓ-trap through a clean-up catalyst downstream of the NOₓ-trap.

38. The method of claim 24, further comprising the step:
(e) passing the stream exiting the NOₓ-trap during step (d) through a second oxidation catalyst downstream of the NOₓ-trap to further oxidize unburned hydrocarbons.

39. A method of reducing the amount of unburned hydrocarbons in exhaust gases from a lean-burn gasoline engine, which method comprises the steps of:
(a) operating a gasoline engine at λ>1 conditions and forming an exhaust stream from the engine;
(b) passing the exhaust exiting the engine from step (a) through an SOₓ trap to trap and store SOₓ;
(c) passing the stream exiting the SOₓ trap through a first oxidation catalyst to oxidize unburned hydrocarbons from the engine to generate an oxidized stream;
(d) passing the oxidized stream exiting the first oxidation catalyst of step (c) through an NOₓ-trap to trap and store NOₓ;
(e) periodically running the gasoline engine rich so that the NOₓ trapped and stored during step (d) is catalytically reduced in the presence of unburned hydrocarbons from the engine running under rich conditions; and
(f) passing the stream exiting the NOₓ-trap during step (e) through a second oxidation catalyst downstream of the NOₓ-trap to further oxidize unburned hydrocarbons.

40. The method of claim 39, wherein the first oxidation catalyst of step (c) comprises a hydrocarbon trap.

41. A method of reducing the amount of unburned hydrocarbons in exhaust gases from a lean-burn gasoline engine, which method comprises the steps of:
(a) operating a gasoline engine at λ>1 conditions and forming an exhaust stream from the engine;
(b) passing the exhaust exiting the engine from step (a) through an SOₓ trap to trap and store SOₓ;
(c) passing the stream exiting the SOₓ trap through a first oxidation catalyst to oxidize unburned hydrocarbons from the engine to generate an oxidized stream;
(d) passing the oxidized stream exiting the first oxidation catalyst of step (c) through an NOₓ-trap to trap and store NOₓ;
(e) periodically running the gasoline engine rich so that the NOₓ trapped and stored during step (d) is catalytically reduced in the presence of unburned hydrocarbons from the engine running under rich conditions; and
(f) passing the stream exiting the NOₓ-trap during step (e) through a clean-up catalyst downstream of the NOₓ-trap.

42. A lean-burn gasoline engine comprising an exhaust system, which system comprising a first oxidation catalyst for oxidizing unburned hydrocarbon (HC) during λ>1 conditions, a NOₓ-trap downstream of the oxidation catalyst, by-pass means arranged between an upstream end and a downstream end of the oxidation catalyst and means for switching at least some exhaust gas flowing in the exhaust system to flow in the bypass during rich or stoichiometric running conditions, thereby substantially to prevent bypassed exhaust gas from contacting the first oxidation catalyst.

43. The engine according to claim 42, further comprising a second oxidation catalyst downstream of the NOₓ-trap.

44. The engine according to claim 42, wherein the first or second oxidation catalyst is selected from the group consisting of: a platinum group metal and a mixture of any two or more platinum group metals.

45. The engine according to claim 44, wherein the platinum group metal is platinum or palladium.

46. The engine according to claim 42, wherein the first oxidation catalyst also comprises a hydrocarbon trap.

47. The engine according to claim 43, wherein the hydrocarbon trap includes a zeolite.

48. The engine according to claim 47, wherein the hydrocarbon trap further includes at least one of alumina, silica-alumina, titania and zirconia.

49. The engine according to claim 47, wherein the zeolite is selected from the group consisting of: β-zeolite, γ-type zeolite, ZSM-5 type zeolite and US γ-type zeolite.

50. The engine according to claim 46, wherein the hydrocarbon trap comprises platinum on alumina.

51. The engine according to claim 42, wherein the exhaust system further comprises a three-way catalyst (TWC).

52. The engine according to claim 42, wherein the system further comprises a SOₓ-trap upstream of the NOₓ-trap.

53. The engine according to claim 51, wherein the TWC is upstream of the NOₓ-trap and wherein the exhaust system further comprises a SOₓ-trap upstream of the NOₓ-trap and downstream of the TWC.

54. The engine according to claim 42, further comprising a clean-up catalyst downstream of the NOₓ-trap.

55. The engine according to claim 42, wherein the exhaust system comprises a substrate supporting, each in a distinct zone, the first oxidation catalyst and the NOₓ-trap.

56. The engine according to claim 55, wherein the substrate is a flow-through monolith.

57. The engine according to claim 42, wherein the exhaust system comprises a shell or can including the first oxidation catalyst and NOₓ-trap.

58. The engine according to claim 42, wherein the engine is a gasoline direct injection engine.

59. A vehicle including an engine according to claim 42.

60. The engine according to claim 51, wherein the TWC is in the close-coupled position.

61. The engine according to claim 42, wherein the means for switching comprises an engine control unit (ECU) programmed, in use, to switch at least some exhaust gas flowing in the exhaust system to flow in the bypass during rich- or stoichiometric-running conditions.

62. The engine according to claim 42, wherein the means for switching comprises at least one valve.

63. The engine according to claim 42, wherein the means for switching controls the rate of exhaust gas bypass.

64. The engine according to claim 63, wherein the rate of exhaust gas bypass is from 50% to 100%.

65. The engine according to claim 63, wherein the rate of exhaust gas bypass is from 60% to 90%.

66. The engine according to claim 63, wherein the rate of exhaust gas bypass is from 70% to 80%.
